(19) United States
(12) Patent Application Publication
(10) Pub. No.: US 2002/0026470 A1
(43) Pub. Date: Feb. 28, 2002

(54) Addressing server

(75) Inventors: Wolfgang Lautenschlager, Weissach-Flacht (DE); Hartmut Weik, Stuttgart (DE); Lothar Krank, Ditzingen (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/939,690

(22) Filed: Aug. 28, 2001

(30) Foreign Application Priority Data
Aug. 29, 2000 (DE) 100 42 267.5

(51) Int. Cl. G06F 17/00

(52) U.S. Cl. 709/1; 709/100

(57) ABSTRACT

The invention relates to a method, an addressing server and a computer product for supporting the provision of communications services by means of an IP communications network. A request message R with a hyper-address, which is formed from a service indicator of a communications service and a service-provider-independent universal address of a subscriber, is transmitted via the IP communications network to an addressing server. The addressing server generates from the service indicator and the service-provider-independent universal address of the subscriber a service-provider-specific hyper-address of the subscriber by means of access to a service provider porting database. This service-provider-specific hyper-address of the subscriber is converted into an IP address for the provision of this communications service.

### BACKGROUND OF THE INVENTION

The invention is based on a priority application DE 100 42 267.5 which is hereby incorporated by reference. The invention relates to a method, an addressing server and a computer product for supporting the provision of communications services by means of an IP communications network, a service-provider-specific hyper-address being converted in the method into an IP address.

The invention starts out from the addressing of subscribers that is common today when utilizing communications services on the Internet.

In the communications service “e-mail”, the address of a subscriber is formed from the name of the mailbox of the subscriber and the domain name of the server that supplies the subscriber with the “e-mail” service. The domain name of this server is not used here directly for routing in the Internet. A domain name server converts the part of the address required for routing to the target mail server, namely the domain name, into a numerical IP address.

An example of an address used in the communications service “e-mail” for addressing a subscriber is: richard@goperator1.de, “richard” designating the name of the mailbox of the subscriber and “operator1.de” describing the domain of the operator that supplies the subscriber with the “e-mail” service. The operator name is thus part of the address in some form. The structure of this address thus does not a priori facilitate operator portability of the address. If a subscriber changes

### SUMMARY OF THE INVENTION

The object of the invention is to organize the routing of data by an IP communications network more efficiently.

This object is achieved by a method, an addressing server and a computer product for supporting the provision of communications services by means of an IP communications network according to the teaching of claim 1, 6, or 7.

The invention is based here on the idea of supplying an address portability server for an IP communications network, which server facilitates provider- and service-independent addressing for various types of communications services supplied via the IP communications network and provided in each case by various service providers. For this purpose, this address portability server converts a hyper-address, which is constructed from a service indicator and a universal address that is independent of the service provider, into a service-specific and service-provider-specific “normal” Internet hyper-address.

The advantage of the invention consists in the fact that universal addressing of subscribers is facilitated independently of the communications service and service provider, due to which the effectiveness of data routing is increased.

Furthermore, user-friendliness is increased: it enables the user to use simple and easy to remember addresses. The basic address parts are used for various services. The user thus only has to remember them once. The service provider may change arbitrarily without this leading to a change of address, so that the addresses are valid for a long time.

Advantageous configurations of the invention are to be inferred from the subclaims.

### BRIEF DESCRIPTION OF THE DRAWINGS

The invention is explained below with reference to several practical examples with the aid of the enclosed drawings.

FIG. 1 shows a block diagram of a communications system with an addressing server according to the invention.

FIG. 2 shows a flow chart to explain the sequence of a method according to the invention.

FIG. 3 shows a functional representation of the addressing server according to FIG. 1.

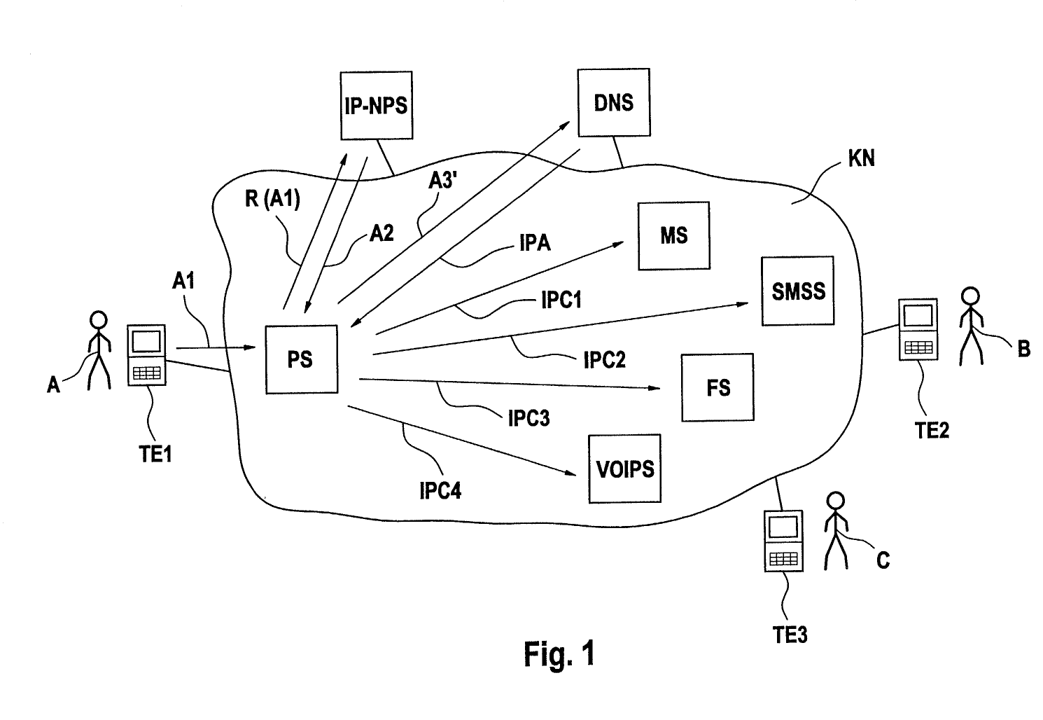

FIG. 1 shows a communications system with a communications network KN, several servers IP-NPS, DNS, MS, SMSS, FS, VOIPS and several terminals TE1 to TE3, which are each assigned to a subscriber A, B or C.

The communications network KN is an IP communications network, i.e. a communications network that uses an IP protocol (IP=Internet protocol) as a Layer 3 protocol. Data communications services and also synchronous speech or image communications services are supplied for example to subscribers A to C via the communications network KN.

The communications network KN can be formed from several sub-networks that are separated organizationally and/or physically from one another. These sub-networks are assigned for example to different network providers. The sub-network networks can also be based on different physical networks or themselves be composed of different physical networks, which are connected to one another via routers, bridges or gateways. Some individual sub-networks are for example access networks based on Ethernet or Token-Ring MAC protocols (MAC=Medium Access Control) and other sub-networks are backbone networks based on ATM (=Asynchronous Transfer Mode) or DQDB (Double Queue Distributed Bus).

An IP protocol (IP=Internet protocol) is used in all these sub-networks as a Layer 3 protocol. As a transport layer the TCP (Transport Capability Part) or UDP protocol (UDP=User Datagram Protocol) sits on this Layer 3 protocol as a transport protocol. The communications services provided via the communications network KN are then constructed on these Layer 4 protocols.

The terminals TE1 to TE3 are computers that are provided with suitable software and hardware for connection to sub-networks of the communications network KN spatially assigned to them. The terminals TE1 to TE3 can also be IP telephones or WEB phones or mobile terminals with a WAP or UMTS capability (WAP=Wireless Application Protocol, UMTS=Universal Mobile Telecommunication System), however. The number of terminals TE1 to TE3 is selected as an example. Furthermore, the terminals TE1 to TE3 have applications programs, which enable them to use one or more of the communications services supplied via the communications network KN.

The network access provider of subscriber A facilitates the latter's access to the communications network KN1 via server PS by means of the terminal TE1. The server PS makes further services available to terminal TE1, which services are provided via the communications network KN. Examples of such services are gateway functions for access to the WWW (world wide web), e-mail services, homepages, newsgroups.

It is also possible to dispense with the server PS. Here it is advantageous that at least some functions of the server PS are provided directly by the terminal TE1. For example, terminal TE1 can communicate in the same way as described below with reference to the server PS with the servers IP-NPS, DNS, MS, SMSS and FS. These functions described below with reference to the server PS are thus provided directly by terminal TE1.

The servers MS, SMSS, FS and VOIPS each control the provision of a special communications service for one or more subscribers, for example for subscribers B and C. The servers MS, SMSS, FS and VOIPS each consist of one or more computers, which are connected to the communications network KN and on which applications programs sit that take care of this control function in each case. However, it is also possible for a computer of this kind to provide the function of several of the servers MS, SMSS, FS and VOIPS. The number of servers MS, SMSS, FS and VOIPS has been chosen as an example: each of the communications services offered by the servers MS, SMSS, FS and VOIPS can be offered by several service providers, which then each have at least one server of this kind.

The server MS supplies an e-mail service. The server SMSS supplies a short message service, which transmits short messages to mobile terminals. The server FS supplies a fax service, which converts electronic documents into fax format and transmits them as a fax to fax terminals. The server VOIPS provides a VOIP service (VOIP=Voice over IP), which facilitates the set-up of synchronous voice channels via the communications network KN. The server VOIPS can also be a VOIP gateway and gatekeeper, for example. It is also possible for further servers, facilitating video communication or videoconferencing for example, to be integrated into the communications system like the servers MS, SMSS, FS and VOIPS.

The server IP-NPS is an addressing server, i.e. a server that performs address conversion. The server IP-NPS converts a hyper-address, which is formed from a service indicator of a communications service and a universal address of a subscriber that is independent of the service provider, into a service-provider-specific hyper-address.

The server DNS is a domain name server. This server converts a domain name into an IP address.

To communicate by means of a special communications service with another subscriber, for example with subscriber B, a hyper-address of subscriber B, namely a hyper-address A1, is transmitted by the terminal TE1 to the server PS. The term hyper-address should be understood in this context to mean a higher1 level address, which cannot be used directly for routing (level 3) in the communications network KN. The hyper-address A1 can also be part of a data set here, which is to be communicated by means of the special communications service to subscriber B. The hyper-address A1 is formed from a service indicator of the special communications service and a universal address of subscriber B that is independent of the service provider.

A service-provider-independent universal address means that this address describes subscriber B independently of the special communications service selected and independently of the service provider providing the communications service: the universal address thus remains the same, regardless of which communications service is selected and regardless of whether subscriber B or also subscriber A changes the service provider of the selected communications network. A universal hyper-address of this kind is the name of the subscriber, for example, in combination with further specifying properties such as address, address components, birthday, or also name abbreviation, synonyms and telephone numbers.

The service indicator of address A1 can consist for example of an abbreviation of the desired communications service, for example m for e-mail, f for fax, s for short message to mobile terminals, v for VOIP communication. A further option consists in using special characters, for example @ for e-mail, f with a squiggle for fax etc. A further option naturally consists in the desired communications service being described by name, for example “fax” describes the fax service.

The server PS then sends a request message R(A)1 with the hyper-address Al, which is formed from a service indicator of a communications service and a service-provider-independent universal address of a subscriber, via the communications network KN to the server IP-NPS, which provides the function of an addressing server. For addressing the request message R(A)1, the server PS requires knowledge of the IP address of the server IP-NPS. The request message R(A)1 consists for example of a UDP message, which is addressed to the IP address of the server IP-NPS and transports the hyper-address Al.

The server IP-NPS generates a service-provider-specific hyper-address of the subscriber from the service indicator and the service-provider-independent universal address of the subscriber by means of access to a service provider porting database. The server thus generates an address A2 from address A1, which address A2 is a service-provider-specific hyper-address of subscriber B.

The form of the service-provider-specific hyper-address is both dependent in its format on the desired communications service and dependent in its content on the service provider that is to provide this communications service. It thus also addresses the service provider that is to provide the selected communications service. An example of a hyper-address of this kind is an e-mail address of subscriber B, which consists of the designation of the mailbox of subscriber B and the domain name of the server MS which supplies this communications service for subscriber B. Both the designation of the mailbox and the domain name are dependent on the provider of the service and the format of this hyper-address is dependent on the selected communications service.

The service-provider-specific hyper-address of subscriber B, i.e. address A2, is converted into an IP address IPA for the provision of this communications service. Depending on the service selected, this IP address specifies a service provider server, thus one of the servers MS, SMSS, FS or VOIPS or also a terminal of subscriber B. This conversion is provided by the server DNS. However, it is also possible that this conversion function is provided by the server IP-NPS or the server PS.

To convert the address A2, the server transmits part of address A2, to be precise an address A3, to the server DNS. Address A3 is the part of the address A3 which specifies the service provider of the communications service selected. If an e-mail service is selected, then the address A3 is formed for example from the domain name of the mail server that supplies the e-mail service to subscriber B. It is of course also possible for the entire address A2 to be transmitted by the server PS to the server DNS, and for the latter to determine the address IPA from the address A2.

The server PS then initiates communication with subscriber B via the selected communications service by means of the addresses A2 and IPA. The address IPA is used to address that server of the servers MS, SMSS, FS or VOIPS in the communications network KN that is responsible for controlling the selected service in the communications network KN. This depends on the type of service, service provider, e.g. service operator, selected target subscriber and possibly also on the initiating subscriber. The address A2 is required for the addressing of subscriber B with regard to this server. If an e-mail communication to subscriber A is thus selected, then a service message IPC1 is transmitted to the server MS. If another communications service is selected, a corresponding service message IPC2, IPC3 or IPC4 is sent in each case to the servers SMSS, FS or VOIPS. The service message can also contain only a part of the address A2 here. If address A2 is an e-mail hyper-address, for example, the service message IPC1 only needs to contain the designation of the mailbox of subscriber B.

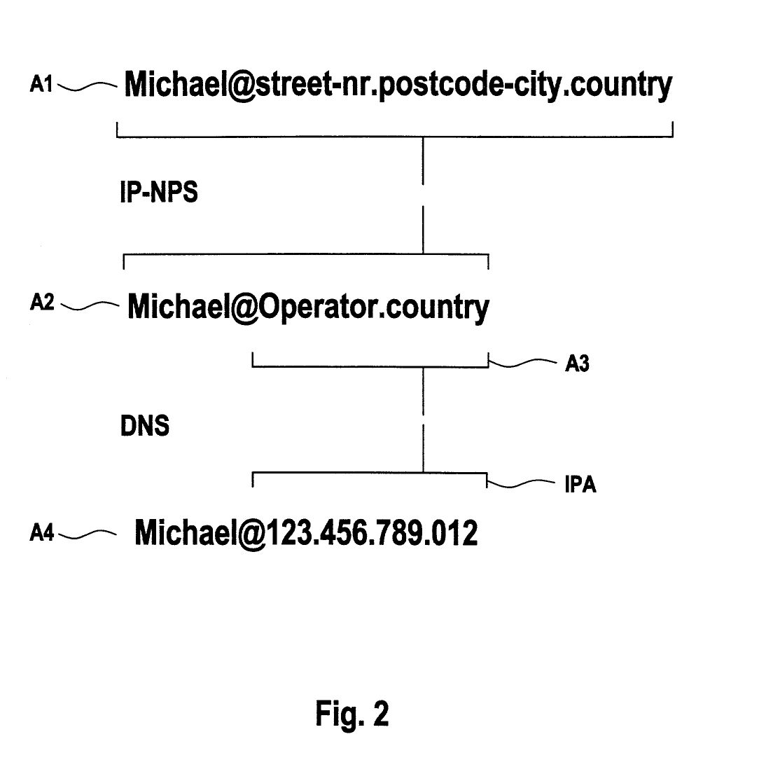

Address conversion according to FIG. 1 is explained again by way of example with reference to FIG. 2.

FIG. 2 shows the servers IP-NPS and DNS, the addresses A1 to A3 and IPA, and an address A4.

Address A1 is formed from a part of the name of subscriber B and the latter's address as a universal hyper-address and the service indicator @. Address A1 is converted by the server IP-NPS into address A2. A part of address A2, address A3, is converted by the server DNS into the address IPA. The address A4 is thus present in the server PS, by means of which address the desired communication can be addressed to subscriber B. It is also possible here for the function of the server DNS to be provided by the server IP-NPS and the address A4 to be transmitted by the server IP-NPS to the server PS on request message R(A1).

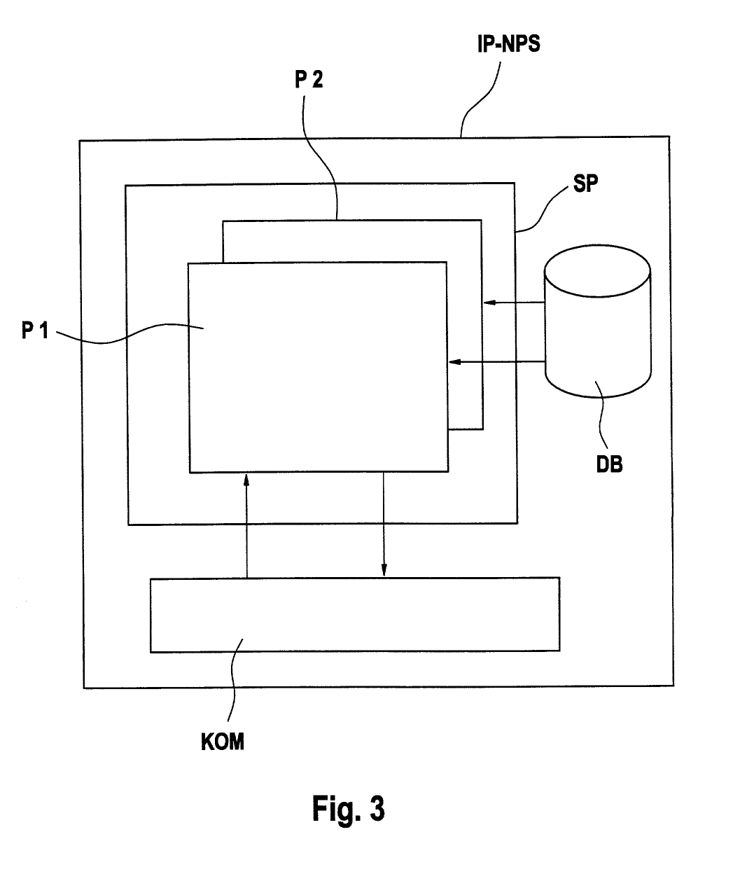

The precise mode of operation of the server IP-NPS is now explained with reference to FIG. 3.

The server IP-NPS is formed by one or more computers connected to one another, on which a software platform consisting for example of an operating system and database system sits. On the system platform formed by these components, an applications program is executed which controls the mode of operation described below of the server IP-NPS. This applications program forms both seen for itself or recorded on a computer-readable storage medium a software product SP, which controls the mode of operation described below of the server IP-NPS in connection with the system platform.

From a functional point of view, the server IP-NPS has a communication unit KOM, a database DB and several processes P1 and P2, which are generated on execution of the applications program of the software product SP on the system platform of the server IP-NPS.

The communication unit KOM supplies the functional units required for communication via the communications network KN. These are in particular the functional units required for processing the UDP/IP protocol stack.

The database DB is a service provider porting database. In a database DB, information is stored on which communications service is to be provided for which subscribers by which service providers. For this purpose, information on the responsible service provider is stored in the database DB for each subscriber depending on several communications services. The subscriber can be specified in the database DB by one or also by more service-provider-independent universal addresses of the subscriber. A communications service can be specified by one or also by more service indicators of the communications service. The responsible service provider can also be dependent on further information about the subscriber initiating the communications service. The information about the responsible service provider can consist of a service-provider-specific hyper-address or also of part of a service-provider-specific hyper-address.

The function of processes P1 and P2 is explained by way of example with reference to the function of process P1.

Process P1 is generated if the server IP-NPS receives a request message with a hyper-address via the IP communications network, which address is formed by a service indicator of a communications service and a service-provider-independent universal address of a subscriber. Process P1 then generates from the service indicator and the service-provider-independent universal address of the subscriber a service-provider-specific hyper-address of the subscriber by means of accessing the database DB. It then transmits this hyper-address back to the server PS. Process P1 is then cleared again. Here process P1 accesses the database DB, using the service indicator and the service-provider-independent universal address of the subscriber as a search key, and as a result receives the information about the responsible service provider assigned to this combination in the database DB. Process P1 then generates by means of this information the service-provider-specific hyper-address of the subscriber.

It is also possible here for the server IP-NPS to comprise several hierarchically organized sub-addressing servers. The request message R(A1) is thus forwarded from sub-addressing server to sub-addressing server until the sub-addressing server that provides the functions described above for the request message R(A1) has been determined. This is particularly advantageous if address A1 is hierarchically structured and thus country, town, street, . . . are separable as sub-information, for example.

1. Method for supporting the provision of communications services by means of an IP communications network, a service-provider-specific hyper5 address being converted in the method into an IP address, wherein a request message R with a hyper-address, which is formed from a service indicator of a communications service and a service-provider-independent universal address of a subscriber, is transmitted via the IP communications network to an addressing server, that the addressing server generates a service-provider-specific hyper-address of the subscriber from the service indicator and the service-provider-independent universal address of the subscriber by means of access to a service provider porting database, and that this service-provider-specific hyper-address of the subscriber is converted into an IP address for the provision of this communications service.

2. Method according to claim 1, wherein two or more service-provider-independent universal addresses are assigned by the addressing server to one and the same subscriber.

3. Method according to claim 1, wherein the service-provider-independent universal address of the subscriber includes a postal address of the subscriber.

4. Method according to claim 1, wherein the service-provider-independent universal address of the subscriber includes a telephone number of the subscriber.

5. Method according to claim 1, wherein the addressing server comprises several hierarchically organized sub-addressing servers.

6. Addressing server for supporting the provision of communications services by means of an IP communications network, wherein the addressing server is configured so that, when it receives a request message R with a hyper-address, which is formed from a service indicator of a communications service and a service-provider-independent universal address of a subscriber, via the IP communications network, it generates a service-provider-specific hyper-address of the subscriber from the service indicator and the service-provider-independent universal address of the subscriber by means of access to a service provider porting database.

7. Software product for supporting the provision of communications services by means of an IP communications network, wherein the software product in combination with a computer forms an addressing server, which is configured so that, when it receives a request message R with a hyper-address, which is formed from a service indicator of a communications service and a service-provider-independent universal address of a subscriber, via the IP communications network, it generates a service-provider-specific hyper-address of the subscriber from the service indicator and the service-provider-independent universal address of the subscriber by means of access to a service provider porting database.
